(19) United States
(12) Patent Application Publication
(10) Pub. No.: US 2008/0219014 A1
(43) Pub. Date: Sep. 11, 2008

(54) Bicycle bumper with a light generating a bike lane

(76) Inventor: Byron Loibl, Wichita, KS (US)

Correspondence Address: FAY SHARPE LLP, 1100 SUPERIOR AVENUE, SEVENTH FLOOR, CLEVELAND, OH, 44114, US

(21) Appl. No.: 12/074,922

(22) Filed: Mar. 7, 2008

Related U.S. Application Data
(60) Provisional application No. 60/905,712, filed on Mar. 8, 2007.

(51) Int. Cl. F21V 33/00

(52) U.S. Cl. 362/473

(57) ABSTRACT

A bicycle bumper system with a light source which creates a bike lane is disclosed. The bicycle bumper includes a sturdy lightweight body generally made from a single sheet comprising a center wall and at least one sidewall. The sidewall includes a light source which shines a streak of light displaying a minimal safe passing distance on the bicycle's riding surface. The bumper also includes a rear light which may be configured to blink and protect the cyclist from rear impact.

### BACKGROUND OF THE DISCLOSURE

This application claims priority from and benefit of the filing date of U.S. Provisional Patent Application Ser. No. 60/905,712, filed on Mar. 8, 2007, and said prior application is expressly incorporated by reference.

This disclosure relates to a system for increasing the safety of a cyclist's ride. More particularly, this disclosure relates to an apparatus that may be placed on a vehicle that will shine an image that signifies a safe distance for a motorist to approach the cyclist, especially in the absence of a bike lane.

While this disclosure is particularly directed towards a safety bumper for bicycles, and thus will be described with particular reference thereto, it will be appreciated that this disclosure will have usefulness in other fields and applications. For example, this disclosure may be useful as a safety device for a variety of vehicles, including motorcycles, personal transportation devices, golf carts, etc.

By way of background, studies show that more than half of Americans live within 10 miles of their regular destination. Many of these people avoid driving whenever they can. These studies also show that many of these people would consider using a bicycle as an alternate term of transportation. After all, riding bicycles has many advantages.

One advantage to riding a bicycle, is it is much simpler to park a bicycle as opposed to an automobile. Another advantage is that bicycles do not use gasoline. With the price of gas increasing, bicycles may be a good way for individuals to save money. Another advantage of bicycles is that a cyclist can get to their destination while exercising. As many health care professionals recommend a minimum of 30 minutes of physical activity on most, if not all, days of the week.

However, bicycles are not a common form of transportation in the United States. In the United States, the road is dominated by automobiles. Because the roadway is dominated by automobiles and few people use bikes as a form of transportation, there are very few bike lanes available. This creates tension on the roadway between those that do use bicycles and automobiles drivers. Because bicycles have to share the roadway with larger automobiles, it can sometimes be difficult for cyclists to get from point A to point B.

Therefore, many people do not ride bicycles because of the dangers of riding on a roadway, especially with no bike lanes. This problem is often compounded at night when it can be difficult to see a cyclist on the road. Therefore, there is a need in the art for a device that decreases the hazards that a cyclist may face when riding a bicycle. Furthermore, there is a need in the art to design a system or device which will protect a cyclist from impact. There is also a need for a device which will allow a cyclist to be illuminated, especially at night. These needs are highlighted when there is no bike lane on the roadway for the cyclist to ride.

The present disclosure contemplates a new and improved system which resolves the above-referenced difficulties and others.

### SUMMARY OF THE DISCLOSURE

An apparatus for an LED bumper panel which alerts automobile drivers of a cyclist's presence is provided. This disclosure details a device that includes a bumper which is attached to a bicycle that not only protects the bicycle from an impact, but also shines a light on the ground which signifies a minimum safe passing distance required by a cyclist. The disclosed device enhances the safety of a cyclist by utilizing a personal lane light which facilitates communication between surround automobiles and cyclists.

In one aspect of the present disclosure a system for increasing the safety of a cyclist comprising a bumper having at least one side wall affixed to at least one portion of a cycling machine configured to protect the cycling machine wheel from impact and a first light source affixed to the side wall adjacent to the cycling machine and configured to shine an image on the surface that the cycling machine is traveling upon.

In accordance with another aspect of the present disclosure, the system further includes a second light source affixed to the associated cycling machine configured to increase the visibility of the cycling machine to viewers behind it.

In accordance with another aspect of the present disclosure, the system includes that the first light source is powered by at least one battery.

In accordance with another aspect of the present disclosure, the system includes that the first light source is powered, at least in part, by the motion of the associated cycling machine.

In accordance with another aspect of the present disclosure, the system includes that the image shown on the surface that the cycling machine is traveling on, is a streak of light running parallel to the direction of travel.

In accordance with another aspect of the present disclosure, the system includes that the lane boundry shines on the surface beneath the cycling machine laterally between one and two feet from the center line of the cycling machine.

In accordance with another aspect of the present disclosure, the system includes that the first light source further includes a laser light emitter.

In accordance with another aspect of the present disclosure, the system includes that the first light source also includes at least one light emitting diode.

In accordance with another aspect of the present disclosure, the system includes that the bumper further comprises a center wall and a second side wall where the ends of the side walls distill to the center wall and are adapted to affix to the axel or frame of the associated cycling machine wheel.

In accordance with another aspect of the present disclosure, the system includes that the associated cycling machine is a bicycle.

In accordance with another aspect of the present disclosure, the system includes that the first side wall has a case engaging portion and a hollow casing is positioned adjacent to the case engaging portion configured to engage the first light source and the system also includes a second light source affixed to the center wall of the bumper wherein the second light source is configured to blink.

In accordance with yet another aspect of the present disclosure, a bicycle bumper comprises a bumper having a center wall, a first side wall and a second side wall and the second side wall has a wheel engaging portion and a casing engaging portion and a casing adjacent to the casing engaging portion where the casing is configured to encapsulate a lighting mechanism. The lighting mechanism is configured to project a streak of light across the ground alongside an associated wheel.

In accordance with another aspect of the present disclosure, the bicycle safety device also includes a rear light adjacent to the center wall that is powered by a battery.

In accordance with another aspect of the present disclosure, the bicycle safety device includes a solar powered light source coupled with a light sensor.

### DETAILED DESCRIPTION OF THE DRAWINGS

The presently described embodiments and the construction, arrangement and combination of the various parts of the device whereby the objects contemplated are attained as hereinafter more fully set forth specifically pointing out in the claims and illustrated in the accompanied drawings in which:

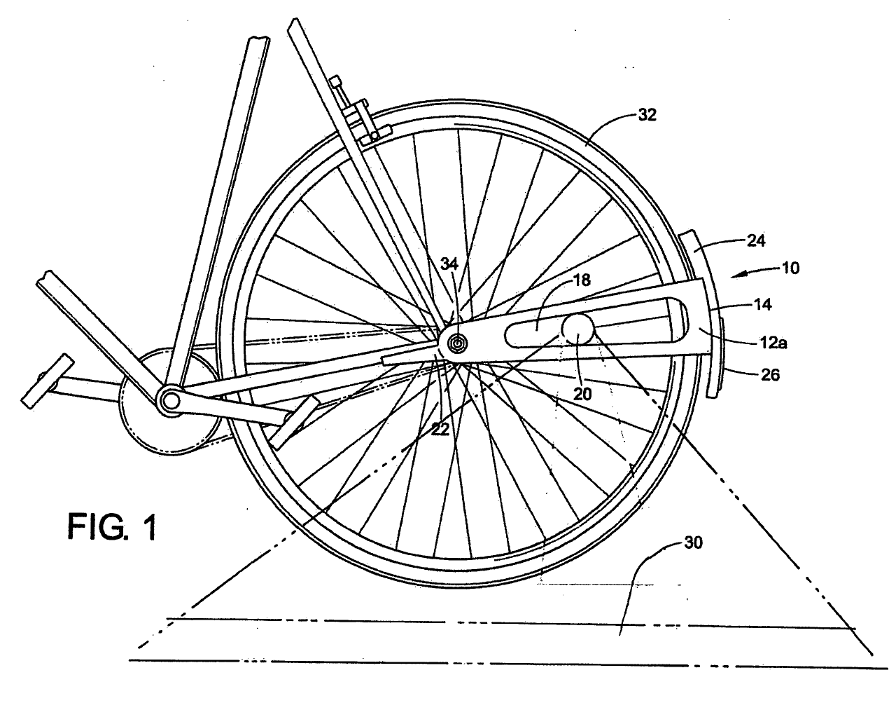

FIG. 1 illustrates the proposed device as attached to a rear wheel of the bicycle.

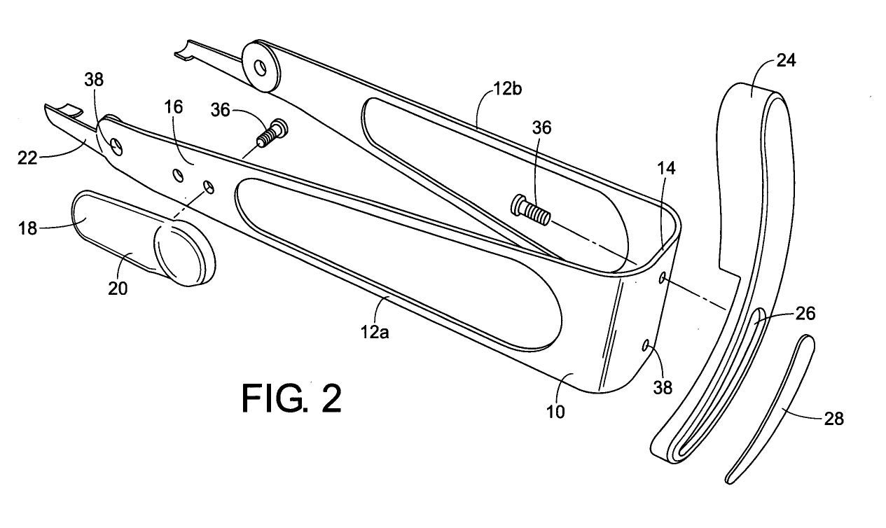

FIG. 2 illustrates an exploded diagram of one embodiment of the present disclosure;

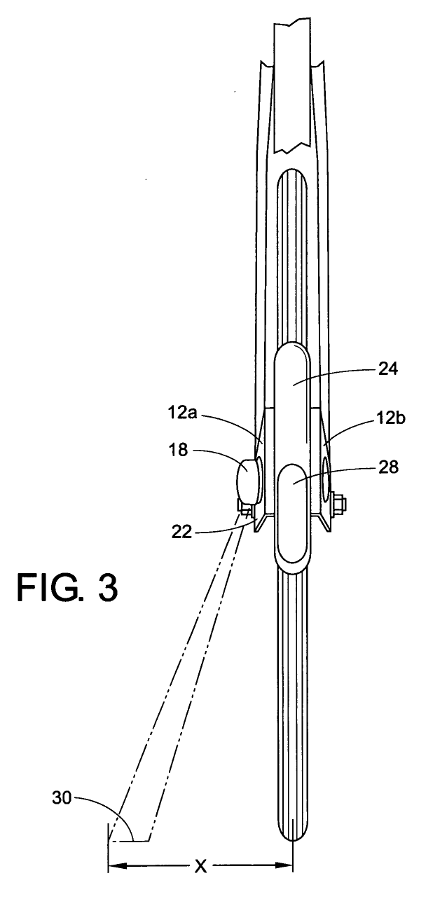

FIG. 3 illustrates a front view of one embodiment according to the present disclosure;

### DETAILED DESCRIPTION

Referring now to the drawings wherein the showings are for the purposes of illustrating the disclosure embodiments only and not for purposes of limiting the claimed subject matter. FIG. 1 provides a view of the overall system into which the present disclosure may be implemented. FIG. 1 shows one embodiment of the present disclosure including a bumper 10, a first side wall 12A, a center wall 14, the rear light 26, a hollow casing 18, a light source 20, and the wheel axel 34. It should be appreciated that FIG. 1 shows merely one embodiment in which the present disclosure may be implemented. The claimed present disclosure may operate in a variety of environments and should not be limited by this one embodiment.

Still referring to FIG. 1, which illustrates the bicycle safety system attached to an associated vehicle. The system includes a bumper 10, having a left sidewall 12a extending from a center wall 14. The sidewall has affixed to it a hollow casing 18. The hollow casing contains a light source covered by a rear light cover 28. The light source is configured to shine a beam 30 on the surface in which the vehicle wheel 32 is riding upon. The center wall 14 has attached to it a rear casing 24 which contains a rear light 26. The sidewall 12a is attached to the vehicle at an axle 34 via the axle engaging portion 22. In another embodiment, the center wall 14 and/or sidewall are attached to the frame of the vehicle. This may be particularly helpful for non-standard vehicles.

The center wall 14 of the bumper 10 is positioned at the rear of the vehicle. The center wall 14 may protect the vehicle from impacts of other vehicles on the road. The center wall 14 may also be used to hold the rear light 26 in place. The rear light 26 may be a shining light or a blinking light which allows other vehicles to see the cyclist on the road.

The light source 20 is used to shine a light beam 30 on the ground in which the vehicle is riding. This beam 30 may act as a personal bike lane signifying a minimal safe passing distance for other vehicles on the road. This beam of light 30 may be shown as a portion of a bike lane e.g., a straight line running parallel to the direction of travel the cycling machine. The beam of light 30 may also be blinking or transmitted as a different color, such as green, red, white, etc.

The light source 20 may be powered through a variety of means. In one embodiment, the light source is powered by a dry cell battery. In another embodiment, the light source is powered, at least in part, by the cyclist's pedaling motion. In yet another embodiment, the light source 20 is solar powered. In this form, the light source may also include a light sensor. Therefore, the light source 20 may turn on automatically at night time, or whenever its not collecting solar power. The rear light 26 may also be powered through similar means. However, it is not necessary that they are powered via the same means.

FIG. 2 illustrates an exploded diagram of one embodiment according to the present disclosure. This embodiment includes a left sidewall 12a, a right sidewall 12b, extending laterally from a center wall 14. Each sidewall comprises an axle engaging portion 22 and a case engaging portion 16. FIG. 2 also shows a rear casing 24 and a rear light 26 being covered by a rear light cover 28. Both the rear casing 24 and the hollow casing 18 may be affixed to the bumper 10 via fasteners 36. In this embodiment, fasteners are shown as simple screws. However, a variety of means may be used in which to fasten the rear casing 24 and hollow casing 18 to the bumper 10. These means include, but are not limited to, a nail, velcro and adhesives, such as glue and/or tape.

As shown in FIG. 2, the bumper 10 has numerous adjustment holes 38 in which to affix the casings 24, 18. These may be useful in adjusting the angles of the lights. The adjustment holes 38 may also be useful in adjusting the bumper to a variety of cycling machines as cycling machines come in a variety of different shapes and sizes.

The bumper 10 may be composed out of a sturdy, lightweight single piece of 0.125 aluminum sheet. The light source 20 and rear light 26 may be Light Emitting Diodes (LEDs). The hollow casing 18 and rear casing 24 may be made from injection molded High Impact Polystyrene (HIPs). These materials may be used in order to be lightweight and function-driven while remaining sturdy and durable. However, it should be noted that other materials may be used and still fall within the scope of the claims. FIG. 2 also shows that the rear casing 24 and hollow casing 18, in particular, easily detach from the rest of the safety device in order that they may be easily replaced in the event of damage.

Now referring to FIG. 3, which is a rear view of one embodiment according to the present disclosure. This figure shows the rear casing 24 adjacent to the rear cover light 28. The first and second sidewall 12a and 12b extend laterally from the bumper. The hollow casing 18 is adjacent to the left sidewall 12a. The left sidewall 12a is also adjacent to the axle engaging portion which is engaged with the axle of the associated vehicle. It should be noted that the hollow casing 18, which contains the light source 20, is on the left hand side of the rider. This is at least in part because cyclist's are generally required by law to be on the right hand side of traffic going in the similar direction. In this form, the beam of light 30, would show the safe passing distance on the correct side of the cyclist.

It should also be noted that the light source 20 in some embodiments may be adjusted in order that the beam of light 30 is approximately 6 to 24 inches from the associated cycling machine's wheel. This distance may vary depending on the comfort level of the cyclist.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A system for increasing the safety of a cyclist, comprising:
a bumper having at least one sidewall affixed to at least one portion of the cycling machine configured to protect an associated cycle machine wheel from impacts; and
a first light source affixed to said at least one sidewall adjacent to said cycling machine and configured to shine an image on the surface beneath the bike.

2. The system of claim 1, further comprising a second light source affixed to a cycling machine configured to increase the visibility of the cycling machine to viewers behind the associated cycling machine.

3. The system of claim 1, wherein the first light source is powered by at least one battery.

4. The system of claim 1, wherein the first light source is powered, at least in part, by the motion of the associated cycling machine.

5. The system of claim 1, wherein the first light source is solar powered.

6. The system of claim 1, wherein the image shone on the surface beneath the associated cycling machine is a lane boundary.

7. The system of claim 6, where the lane boundary is a streak of light running parallel to the direction of travel of the cycling machine.

8. The system of claim 6, wherein the lane boundary shines on the surface beneath the cycling machine laterally between one to two feet from the centerline of the cycling machine.

9. The system of claim 1, wherein the first light source further comprises a laser light emitter.

10. The system of claim 1, wherein the first light source further comprises at least one Light Emitting Diode.

11. The system of claim 1, wherein the bumper further comprises a center wall, a first sidewall, and a second sidewall, where the ends of the sidewalls distal to the center wall are adapted to affix to the hub of the associated cycling machine wheel.

12. The system of claim 1, further comprising a light source.

13. The system of claim 1, wherein
the bumper is affixed to the axles of the associated cycling machine wheel having a center wall, a first sidewall and a second sidewall, the first sidewall having a casing engaging portion;
a hollow casing positioned adjacent to said case engaging portion configured to engage the first light source; and
a second light source affixed to the center wall of the bumper, whee the second light source is configured to blink.

14. A bicycle bumper comprising:
a bumper having a center wall, a first sidewall and a second sidewall, said first sidewall having a casing engaging portion;
a first and second wheel engaging mechanism, said first wheel engaging mechanism positioned laterally adjacent to said first sidewall and said second wheel engaging mechanism positioned laterally adjacent to said second sidewall;
a hollow casing positioned adjacent to said case engaging portion; and
a light emitting diode contained within said hollow casing configured to shine a lane beam boundary.

15. The bumper according to claim 14, further comprising a fender extending from said center wall encircling an associated bicycle wheel.

16. The bumper according to claim 14, wherein said lane beam boundary shines on an associated roadway laterally between one to two feet from said first sidewall.

17. The bumper according to claim 14, further comprising an second light emitting diode located adjacent to said center wall.

18. A bicycle safety device comprising:
a center wall having a base plate;
at least one sidewall extending laterally from said base plate, said sidewall having a wheel engaging portion and a casing engaging portion; and
a casing adjacent to said casing engaging portion, said casing is configured to encapsulate a lighting mechanism, said lighting mechanism is configured to project a streak of light across the ground along side an associated wheel.

19. The bicycle safety device according to claim 18, further comprising a rear light adjacent to the center wall.

20. The bicycle safety device according to claim 18, wherein said lighting mechanism is configured to be adjusted to allow said streak of light to be projected between approximately six to 24 inches from an associated cycling machine's wheel.
